(19) United States
(12) Patent Application Publication
(10) Pub. No.: US 2025/0225848 A1
(43) Pub. Date: Jul. 10, 2025

(54) BREAKAWAY COUPLING DEVICE WITH NOTIFICATION DEVICE

(71) Applicant: Fasteners for Retail, Inc., Twinsburg, OH (US)

(72) Inventors: Brent Ewing, Roscoe, IL (US); Jeff Comstock, Twinsburg, OH (US)

(73) Assignee: Fasteners for Retail, Inc., Twinsburg, OH (US)

(21) Appl. No.: 19/013,834

(22) Filed: Jan. 8, 2025

Related U.S. Application Data
(60) Provisional application No. 63/619,713, filed on Jan. 10, 2024.

(51) Int. Cl. G08B 13/12

(52) U.S. Cl. CPC G08B 13/122

(57) ABSTRACT

A security system, comprising a breakaway coupling device, comprising a coupler component including a key, wherein the coupler component forms a first opening that facilitates a first attachment region, and wherein the key extends out of a first side of the coupler component, and a base component with a first end and a second end opposite the first end, wherein the first end is formed with a cavity opening into a cavity of the base component, and wherein the second end forms a second opening that facilitates a second attachment region, and at least one notification device in communication with the breakaway coupling device.

### CROSS REFERENCE TO RELATED APPLICATIONS

This U.S. patent application claims the benefit of U.S. Provisional Application 63/619,713, filed on Jan. 10, 2024. The disclosure of the prior application is considered part of the disclosure of this application and are hereby incorporated by reference in entirety.

### FIELD

The present disclosure relates generally to a system and device for retail security, and more particularly, to a system and device for identifying entry of a prohibited area.

### BACKGROUND

This section provides background information related to the present disclosure and is not necessarily prior art. In self-service retail establishments, such as grocery stores and the like, it may be necessary to close off or prohibit customers from entering an aisle of a store if a product was spilled on the floor or if the floor was recently cleaned, for example. Identifying when and where an individual has entered a prohibited area and notifying an associate of the retail establishment may be desirable. Existing systems or methods of retail security do not provide such immediate notice when a customer enters a prohibited area. These shortcomings, among others, are addressed by aspects of the present disclosure.

### SUMMARY

One aspect of the disclosure provides a security system. The security system includes breakaway coupling device, comprising a coupler component including a key, wherein the coupler component forms a first opening that facilitates a first attachment region, and wherein the key extends out of a first side of the coupler component and a base component with a first end and a second end opposite the first end, wherein the first end is formed with a cavity opening into a cavity of the base component, and wherein the second end forms a second opening that facilitates a second attachment region, and at least one notification device in communication with the breakaway coupling device.

Implementations of the disclosure may include one or more of the following optional features. In some examples, the at least one notification device includes an audible notification device.

In some further examples, the at least one notification device may be responsive when the coupler component is engaged with the base component. The at least one notification device may be responsive when the coupler component is disengaged with the base component. The at least one notification device may be included in the breakaway coupling device. The at least one notification device may include a remote device. The at least one notification device may communicate with the remote device via radio frequency.

In some configurations, the security system further includes a first tether attaching the coupler component to a first shelf and a second tether attaching the base component to a second shelf. The first tether, the breakaway coupling device, and the second tether form a barrier to entry between the first shelf and the second shelf.

In some other implementations, the key comprises a first side and a second side, the first side and second side each defining a notch. The base component may include a first retainer on one side of the cavity and a second retainer spaced laterally from the first retainer on another side of the cavity, the first and second retainers each having a tooth protruding inwardly toward one another and engaging with the notches of the key.

Another aspect of the disclosure provides a breakaway coupling device. The breakaway coupling device includes a coupler component including a key, wherein the coupler component forms a first opening that facilitates a first attachment region, and wherein the key extends out of a first side of the coupler component, and a base component with a first end and a second end opposite the first end, wherein the first end is formed with a cavity opening into a cavity of the base component, wherein the second end forms a second opening that facilitates a second attachment region, the base component housing a local alarm, comprising an alert component engagable with the key so that responsive to the key being disengaged from the alert component, the local alarm is activated, and responsive to the key being engaged with the alert component, the local alarm is deactivated.

Implementations of this aspect of the disclosure may include one or more of the following optional features. In some examples, the alert component is a movable switch arm that has a first position and a second position. The key may include a first side and a second side, the first side and second side having notches. The base component may include a first cantilevered arm on one side of the cavity and a second cantilevered arm spaced laterally from the first cantilevered arm on another side of the cavity, the first and second cantilevered arms each having a tooth protruding inwardly toward one another and corresponding with the notches of the key.

Another aspect of the disclosure provides a retail environment. The retail environment including a first shelf and a second shelf spaced from and parallel to the first shelf, an aisle extending between and along the first shelf and the second shelf. The retail environment further includes a breakaway coupling device, including a coupler component including a key, wherein the coupler component forms a first opening that facilitates a first attachment region, and wherein the key extends out of a first side of the coupler component and a base component with a first end and a second end opposite the first end, wherein the first end is formed with a cavity opening into a cavity of the base component, and wherein the second end forms a second opening that facilitates a second attachment region. The retail environment further includes a first tether coupled to the first shelf and the first attachment region, a second tether coupled to the second shelf and the second attachment region, and at least one notification device in communication with the breakaway coupling device.

Implementations of this aspect of the disclosure may include one or more of the following optional features. In some examples, the at least one notification device includes a first notification device included in the breakaway coupling device and a second notification device that is remote device. The second notification device may be configured to communicate with the breakaway coupling device via radio frequency. The retail environment may further include a post coupled to and extending from the aisle and supporting the second notification device. The second notification device may be coupled to the first shelf or the second shelf.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of a retail environment including a security system comprising a breakaway coupling device according to an example of the present disclosure;

FIG. 2 is a perspective view of the retail environment of FIG. 1 according to an example of the present disclosure;

FIG. 3 is a perspective view of the breakaway coupling device of FIG. 1, showing a coupler component assembled with a base component;

FIG. 4 is a perspective view of the breakaway coupling device of FIG. 1, showing the coupler component disassembled from the base component;

FIG. 5 is an exploded view of the breakaway coupling device of FIG. 3;

FIG. 6 is a cross sectional view of the breakaway coupling device of FIG. 4, taken along line 6-6 of FIG. 4; and

FIG. 7 is a bottom view of the breakaway coupling device of FIG. 3 with a rear portion of the base component removed from a front portion of the base component according to an example of the present disclosure.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

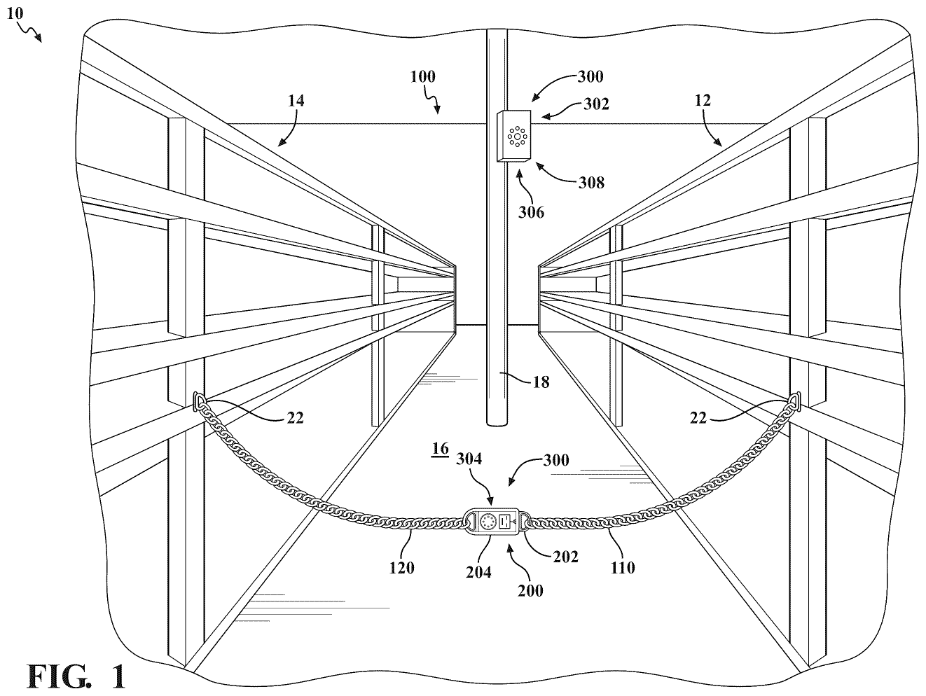

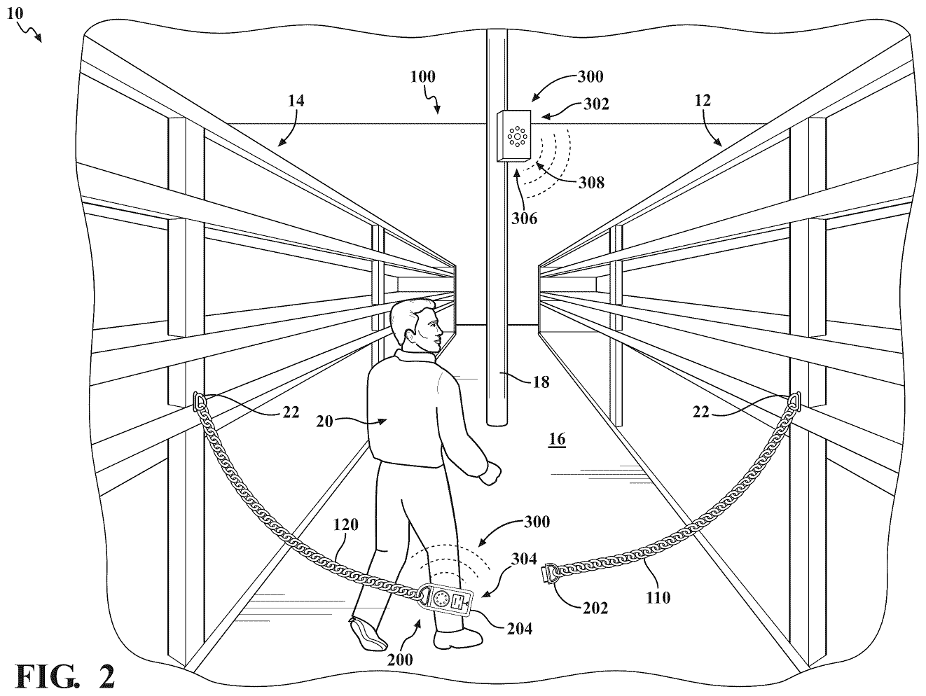

Referring to FIG. 1, an example of a retail environment 10 including a first shelf or product display 12, a second shelf or product display 14, and an aisle 16 extending along and between the first shelf 12 and the second shelf 14 is generally shown. The retail environment 10 may include a post or building support 18 coupled to and extending away from the aisle 16. A security system 100 may be arranged in the retail environment 10. More particularly, the security system 100 may be positioned between the first shelf 12 and the second shelf 14 to form a barrier to entry of the aisle 16. The security system 100 may be desirable to prevent individuals 20 (FIG. 2) from entering an aisle where a product was spilled or was recently cleaned, for example, or to restrict access to secured areas where products are stored. Stated differently, the security system 100 may be desirable to alert one or more attendants of an establishment (e.g., grocery store, convenience store, market, etc.) that the individual 20 has entered the aisle 16 where individuals 20 are prohibited from entering.

The security system 100 may include a first tether 110, a second tether 120, a breakaway coupling device 200, and at least one notification device 300. The first and second tethers 110, 120 may be chain, wire, or a rope for example. The first and second tethers 110, 120 may be respectively coupled to the first and second shelves 12, 14, with hooks 22 that are attached to the first and second shelves 12, 14, for example. The first and second tethers 110, 120 may be attached to the shelves 12, 14 using methods commonly used in retail and/or merchandise settings, such as by fasteners.

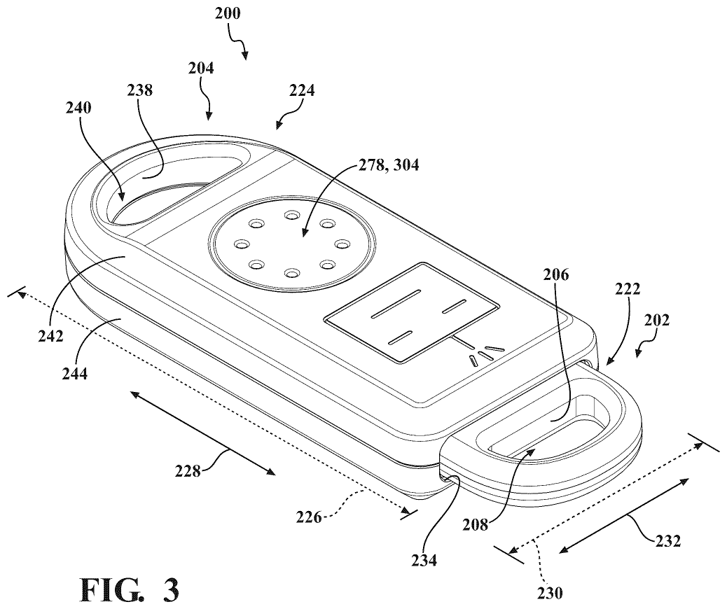

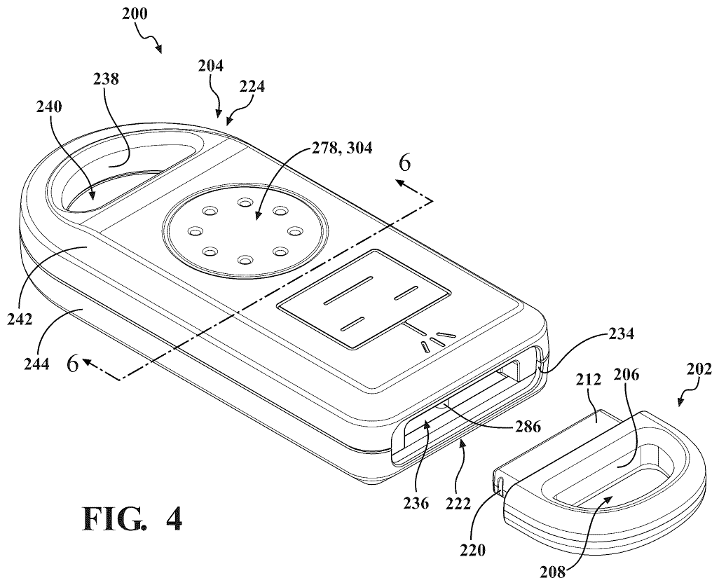

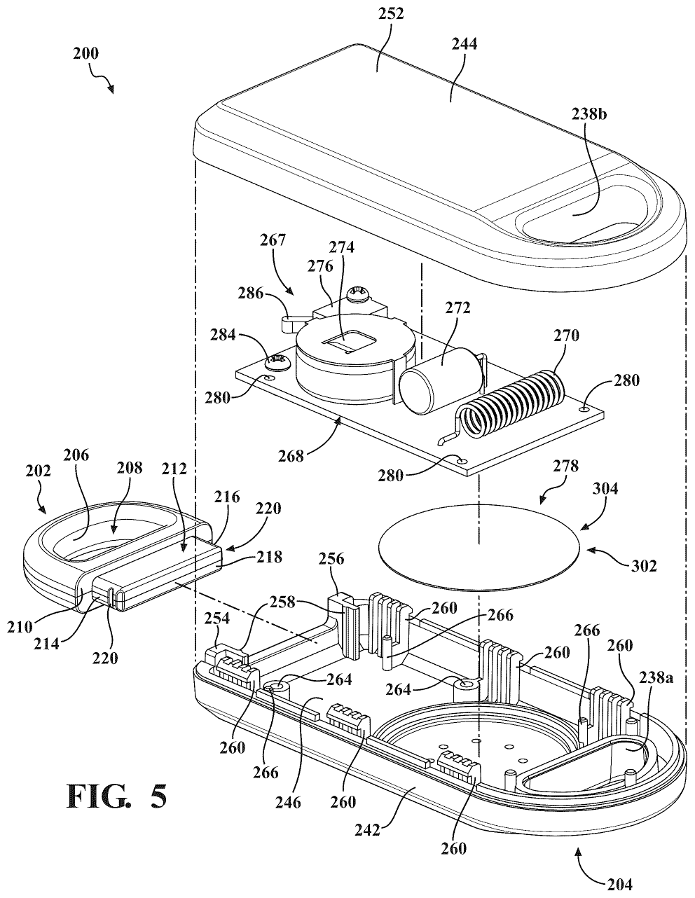

With reference to FIGS. 3 and 4, the breakaway coupling device 200 can include a first or top component 202 that may be coupled to and/or engagable with a second or base component 204. The coupler component 202 includes a first opening 206 that facilitates a first attachment region 208. The first attachment region 208 is configured so that the coupler component 202 may be coupled to the first shelf 12 via the first tether 110, as shown in FIGS. 1 and 2. With reference to FIG. 5, the coupler component 202 can include a first side surface 210 and a key 212 extending from the first side surface 210. The key 212 includes a first side 214, a second side 216 opposite the first side 214, and a distal end 218 extending between the first and second sides 214, 216. The first and/or second sides 214, 216 can have a notch 220, which will be discussed in more detail below with respect to the base component 204.

With reference again to FIG. 3, the base component 204 can have a first end 222 and a second end 224 opposite the first end 222. The base component 204 may have a length 226 with extending in a direction along first or longitudinal axis 228 and a width 230 with extending in a direction along a second or lateral axis 232. The first end 222 includes a cavity opening 234 into a cavity 236 of the base component 204, as shown in FIG. 4. Put differently, the first end 222 of the base component 204 is configured to receive the key 212 of the coupler component 202. The second end 224 includes a second opening 238 that provides facilitate a second attachment region 240. With reference to FIG. 5, the base component 204 a first or front housing portion 242 and a second or rear housing portion 244 which cooperates with the front housing portion 242 to form the base component. As described with respect to FIG. 5, the rear housing portion 244 is removably coupled to the front housing portion 242. The front housing portion 242 includes a front portion 238a of the second opening 238 and the rear housing portion 244 defines a rear portion 238b of the second opening 238b so that the second opening 238 and the second attachment region 240 are formed when the rear housing portion 244 is assembled to the front housing portion 242. With reference to FIG. 5, the front housing portion 242 may have an inner side 246 and an opposite outer side 248. The rear housing portion 244 may have an inner side 250 and an opposite outer side 252. The inner side 246 of the front housing portion 242 and the inner side 250 of the rear housing portion 244 cooperate to define the cavity 236 of the base component 204.

The front housing portion 242 includes a first retainer 254 and a second retainer 256 spaced laterally from the first retainer 254 on either side of the cavity 236. The retainers 254, 256 may be formed as cantilevered arms or projections disposed on the inner side 246 of the front housing portion 242 near the first end 222, adjacent to the opening 234 of the cavity 236. Thus, the first and second retainers 254, 256 can define a portion of the cavity 236 that may receive the key 212 of the coupler component 202. The first and second retainers 254, 256 may each include a tooth 258 (i.e., teeth) that protrudes inwardly toward one another. The teeth 258 correspond and cooperate with one or more of the notches 220 arranged on the first and/or second sides 214, 216 of the key 212 of the coupler component 202. Thus, in assembly, when the key 212 of the coupler component 202 is inserted through the cavity opening 234 and into the cavity 236 of the base component 204, a portion of the key 212 near the third side 218 pushes against the teeth 258 so as to bend or flex the first and second retainers 254, 256 outwardly until the notches 220 mate or otherwise align with the teeth 258, allowing the first and second retainers 254, 256 to return to their nominal or close to nominal positions. When the teeth 258 are arranged in the notches 220, some minimum amount of force on the first and/or base components 202, 204 may be necessary for the coupler component 202 to be removed from the base component 204. For example, with respect to FIG. 2, a person walking through or pushing a shopping cart through the security system 100 may be an example of sufficient force to detach the coupler component 202 from the base component 204. Obviously, other examples may require more or less force to separate the coupler component 202 from the base component 204. For example, a size of the teeth 258 and the notches 220 may be increased or decreased to modify a threshold force required to detach the coupler component 202 from the base component 202 (i.e., larger teeth 258 and notches 220 for increased detachment force). Upon disassembly or when the coupler component 202 is being removed from the cavity 236 of the base component 204 in a direction parallel to the first axis 228, a portion of the key 212 near the distal end 218 biases the teeth 258 to bend or flex the first and second retainers 254, 256 outwardly so the notches 220 can move past the teeth 258. In other words, the first and second retainers 254, 256 may be pushed outwardly by a portion of the key 212 so that the teeth 258 no longer prevent the coupler component 202 from moving axially with respect to the first axis 228. In alternative examples, the notches 220 may be formed on the retainers 254, 256 and the teeth 258 may be formed on the key 212.

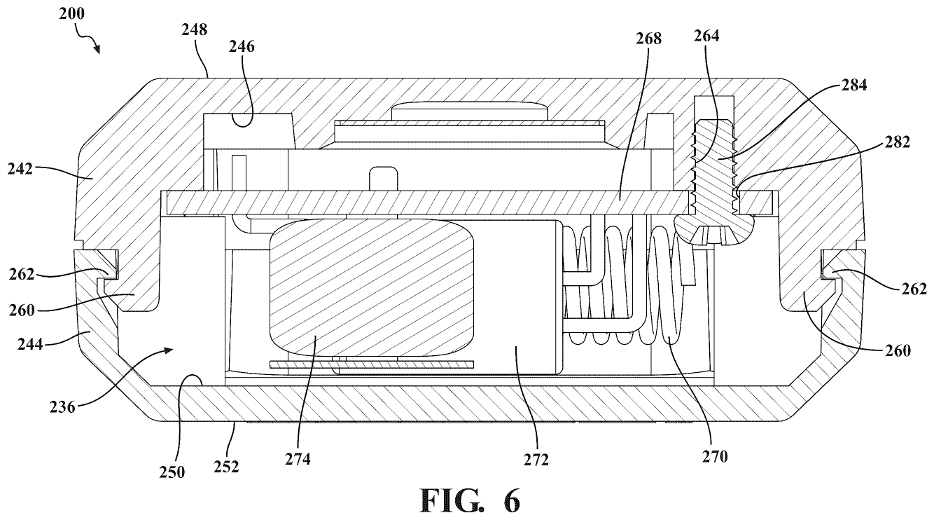

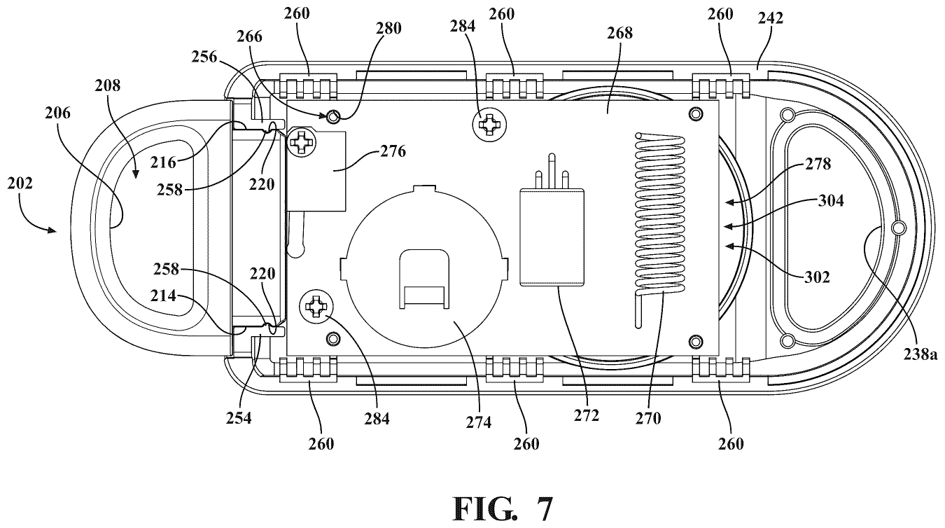

With reference to FIGS. 5 and 7, the front housing portion 242 may include one or more housing clips 260 extending from the inner side 246. The housing clips 260 may engage with a portion of the inner side 250 of the rear housing portion 244 such as a lip 262, as shown in FIG. 6. Thus, the rear housing portion 244 is removably secured to the front housing portion 242. The front housing portion 242 may also include one or more fastener sockets 264 extending from the inner side 246 for attaching a circuit board 268 within the front housing portion 242. One or more alignment features 266 may be arranged on and extend from the inner side 246 of the front portion and may be desirable for aligning the circuit board 268.

With continued reference to FIG. 5, a control system 267 of the coupling device 200 includes circuit board 268 coupled with an antenna 270, a resistor 272, a power source (e.g., a battery) 274, and a switch or circuit 276. A local alarm 278 (e.g., speaker or buzzer) may be housed within the base component 204, is in communication with the circuit board 268, and arranged between the front housing portion 242 and the circuit board 268, as shown in FIG. 5. According to at least one aspect of the present disclosure, the circuit board 268 comprises one or more through holes 280 that can be aligned with the alignment features 266 of the front portion 242. The circuit board 268 may include additional through holes, such as fastener holes 282 (FIG. 6), so the circuit board 268 may be fastened to the fastener openings 264 with fasteners 284. Thus, the circuit board 268 is arranged between the front housing portion 242 and the rear housing portion 244 of the base component 204. The switch 276 includes a movable switch arm or alert component 286 configured to resiliently engage the key 212, for example. When the coupler component 202 is inserted into the cavity opening 234, the distal end 218 of the key 212 engages the movable switch arm 286 so that the movable switch arm 286 is biased to a first position (i.e., creating an open circuit for the circuit board 268) (FIG. 7). When the coupler component 202 is removed from the base component 204 and/or the coupler component 202 is no longer supplying a force on the movable switch arm 286, the movable switch arm 286 moves to a second position (i.e., creating a closed circuit on the circuit board 268) (FIG. 5).

With reference again to FIG. 2, the at least one notification system 300 is shown in the retail environment 10. The at least one notification system 300 can include an audible notification device 302 such as a speaker, buzzer, or alarm, for example. The at least one notification system 300 may include a first notification device 304 (e.g., the local alarm 278) in the breakaway coupling device 200 and/or a second notification device 306 arranged on the post 18, the first shelf 12, and/or the second shelf 14 within the retail environment 10. The second notification device 306 can be a remote device 308. For instance, the breakaway coupling device 200 communicates with the second notification device 306 via radio frequency (RF) signals. By utilizing RF communication, the coupling device 200 is configured to communicate with one or more remote notification devices 308 without the need for actively connecting the coupling device 200 to a network or pairing the coupling device 200 with the notification device. Thus, the coupling device 200 can be easily deployed within a retail environment 10 without additional steps for connecting the coupling device 200 and the remote notification device 308.

In operation, the at least one notification device 30 may be responsive (i.e., enabling or disabling the notification device 30) when the coupler component 202 is disengaged or engaged from the base component 204. For instance, the local alarm 278 (i.e., the first notification device 304) may be configured so that the local alarm 278 is responsive to the key 212 being disengaged from the movable switch arm 286. In other words, the local alarm 278 may be activated (i.e., enable the local alarm 278 to make an audible noise) when the key 212 is disengaged from the movable switch arm 286 and the movable switch arm moves from the first position (FIG. 7) to the second position (FIG. 5). The local alarm 278 may be configured so that the local alarm 278 is responsive to the key 212 being engaged with the movable switch arm 286. Thus, the local alarm 278 may be deactivated (i.e., disable the local alarm 278 from making an audible noise) when the key 212 is engaged with the movable switch arm 286 and the movable switch arm 286 moves from the second position (FIG. 5) to the first position (FIG. 7).

Additionally or alternatively, the remote device 308 may be configured so that the remote device 308 is responsive to the key 212 being disengaged from the movable switch arm 286. In other words, when the key 212 is disengaged from the movable switch arm 286 and the movable switch arm 286 moves from the first position (FIG. 7) to the second position (FIG. 5), the remote device 308 (i.e., the second notification device 306) may receive radio frequency communication from the breakaway coupling device 200 (i.e., from the antenna 270) to activate the remote device 308 (i.e., enable the remote device 308 to make an audible noise). The remote device 308 may be configured so that the remote device 308 is responsive to the key 212 being engaged with the movable switch arm 286. Thus, when the key 212 is engaged with the movable switch arm 286 and the movable switch arm 286 moves from the second position (FIG. 5) to the first position (FIG. 7), the breakaway coupling device 200 terminates communication with the remote device 308 via radio frequency and deactivates the remote device 308 (i.e., disable the remote device 308 from making an audible noise).

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed herein could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A security system, comprising:
a breakaway coupling device, comprising:
a coupler component including a key, wherein the coupler component forms a first opening that facilitates a first attachment region, and wherein the key extends out of a first side of the coupler component, and
a base component with a first end and a second end opposite the first end, wherein the first end is formed with a cavity opening into a cavity of the base component, and wherein the second end forms a second opening that facilitates a second attachment region; and
at least one notification device in communication with the breakaway coupling device.

2. The security system of claim 1, wherein the at least one notification device includes an audible notification device.

3. The security system of claim 1, wherein the at least one notification device is responsive when the coupler component is engaged with the base component.

4. The security system of claim 3, wherein the at least one notification device is responsive when the coupler component is disengaged with the base component.

5. The security system of claim 4, wherein the at least one notification device is included in the breakaway coupling device.

6. The security system of claim 4, wherein the at least one notification device includes a remote device.

7. The security system of claim 6, wherein the at least one notification device communicates with the remote device via radio frequency.

8. The security system of claim 1, further comprising a first tether attaching the coupler component to a first shelf and a second tether attaching the base component to a second shelf.

9. The security system of claim 8, wherein the first tether, the breakaway coupling device, and the second tether form a barrier to entry between the first shelf and the second shelf.

10. The security system of claim 1, wherein the key comprises a first side and a second side, the first side and second side each defining a notch.

11. The security system of claim 10, wherein the base component has a first retainer on one side of the cavity and a second retainer spaced laterally from the first retainer on another side of the cavity, the first and second retainers each having a tooth protruding inwardly toward one another and engaging with the notches of the key.

12. A breakaway coupling device, comprising:
a coupler component including a key, wherein the coupler component forms a first opening that facilitates a first attachment region, and wherein the key extends out of a first side of the coupler component; and
a base component with a first end and a second end opposite the first end, wherein the first end is formed with a cavity opening into a cavity of the base component, wherein the second end forms a second opening that facilitates a second attachment region, the base component housing:
a local alarm, comprising an alert component engagable with the key so that:
responsive to the key being disengaged from the alert component, the local alarm is activated, and
responsive to the key being engaged with the alert component, the local alarm is deactivated.

13. The breakaway coupling device of claim 12, wherein the alert component is a movable switch arm that has a first position and a second position.

14. The breakaway coupling device of claim 12, wherein the key comprises a first side and a second side, the first side and second side having notches.

15. The breakaway coupling device of claim 14, wherein the base component has a first cantilevered arm on one side of the cavity and a second cantilevered arm spaced laterally from the first cantilevered arm on another side of the cavity, the first and second cantilevered arms each having a tooth protruding inwardly toward one another and corresponding with the notches of the key.

16. A retail environment, comprising:
a first shelf and a second shelf spaced from and parallel to the first shelf;
an aisle extending between and along the first shelf and the second shelf;
a breakaway coupling device, comprising:
a coupler component including a key, wherein the coupler component forms a first opening that facilitates a first attachment region, and wherein the key extends out of a first side of the coupler component, and
a base component with a first end and a second end opposite the first end, wherein the first end is formed with a cavity opening into a cavity of the base component, and wherein the second end forms a second opening that facilitates a second attachment region;
a first tether coupled to the first shelf and the first attachment region;
a second tether coupled to the second shelf and the second attachment region; and
at least one notification device in communication with the breakaway coupling device.

17. The retail environment of claim 16, wherein the at least one notification device comprises a first notification device included in the breakaway coupling device and a second notification device that is remote device.

18. The retail environment of claim 17, wherein the second notification device is configured to communicate with the breakaway coupling device via radio frequency.

19. The retail environment of claim 18, further comprising a post coupled to and extending from the aisle and supporting the second notification device.

20. The retail environment of claim 18, wherein the second notification device is coupled to the first shelf or the second shelf.
